(19) United States
(12) Patent Application Publication
(10) Pub. No.: US 2011/0210493 A1
(43) Pub. Date: Sep. 1, 2011

(54) SUBSTRATE ASSEMBLY

(76) Inventor: Tomoyo Murai, Tokyo (JP)

(21) Appl. No.: 13/128,739

(22) PCT Filed: Nov. 24, 2009
(86) PCT No.: PCT/JP2009/069759

§ 371 Date: May 11, 2011

(30) Foreign Application Priority Data
Nov. 25, 2008 (JP) 2008-299312

(51) Int. Cl. B23Q 1/00

(52) U.S. Cl. 269/47

(57) ABSTRACT

Provided is a substrate assembly which satisfies both highly precise positioning and easier assembling. A substrate assembly, formed by positioning a substrate and installing the substrate onto a predetermined member, is configured such that the predetermined member comprises a projection which protrudes toward the substrate, the substrate comprises a hole at a position corresponding to the projection into which the projection is fitted, the projection comprises a small projecting portion on a sidewall surface, and the small projecting portion and a sidewall surface of the projection on the reverse side of the small projecting portion are configured so as to come into contact with a wall surface of the hole to thereby determine a position of the substrate to the predetermined member in a predetermined direction.

### REFERENCE TO RELATED APPLICATION

This application is the National Phase of PCT/JP2009/069759, filed Nov. 24, 2009, which is based upon and claims the benefit of the priority of Japanese patent application No. 2008-299312 filed on Nov. 25, 2008, the disclosure of which is incorporated herein in its entirety by reference thereto.

### TECHNICAL FIELD

This invention relates to a substrate assembly formed by positioning a substrate and installing the substrate onto a predetermined member.

### BACKGROUND

With regard to a substrate assembly which is formed by positioning a substrate and installing the substrate onto a predetermined member, when installing the substrate onto the predetermined member, a projection formed on the predetermined member is fitted into a hole formed on the substrate for positioning the substrate. In Patent Document 1, for example, it is disclosed an escutcheon, in which a substrate, touch panel and liquid crystal are disposed at a back side of a main body of the escutcheon in this order and a cover is further arranged on them and the cover is screwed onto the back side of the main body of the escutcheon, and in which a projection for positioning of roughly L-shaped is provided at a back side of the main body of the escutcheon and a hole for positioning of roughly L-shaped is provided on the substrate for positioning the substrate by fitting the projection into the hole for positioning.

### [Patent Document 1]

Japanese Patent Kokai Publication No. JP-P2007-308054A

### SUMMARY

It should be noted that the content disclosed in Patent Document 1 is hereby incorporated by reference herein in its entirety. The following analyses are given by the present invention.

For positioning by fitting a projection into a hole, it may be applied to reduce a size of the hole for improving the precision of the positioning. However, even when reducing a size of a hole, in a case where there are a plurality of holes into which projections are fitted, it is not possible to reduce a clearance between a projection and a hole into zero due to tolerance of the sizes. It means that there should arise random variation of the positioning sizes and angles corresponding to the tolerance, which causes a limitation of improving the precision of positioning. When such random variation of positioning sizes and angles corresponding to the tolerance arises, in a case where a substrate should be installed onto a predetermined member in a vertically standing position, there may be a risk of difficulty of installing the substrate such as falling toward this side or dropping.

It is a main object of the present invention to provide a substrate assembly which satisfies both highly precise positioning and easier assembling.

According to an aspect of the present invention, there is provided a substrate assembly, formed by positioning a substrate and installing the substrate onto a predetermined member, in which the predetermined member comprises a projection protruding toward the substrate, the substrate comprises a hole at a position corresponding to the projection into which the projection is fitted, and the projection comprises a small projecting portion on a sidewall surface. The small projecting portion and a sidewall surface of the projection on the reverse side of the small projecting portion are configured so as to come into contact with a wall surface of the hole to thereby determine a position of the substrate and the predetermined member in a predetermined direction.

Preferably, the substrate assembly of the present invention is configured such that the predetermined member comprises an L-shaped projection formed in an L-shape as the projection, the substrate comprises an L-shaped hole formed in an L-shape as the hole, the L-shaped projection comprises, as the small projecting portions, a first small projecting portion on one side of a sidewall of a first side region of the L-shape and a second small projecting portion on one side of a sidewall of a second side region that crosses the first side, and the first small projecting portion and a sidewall surface of the L-shaped projection on the reverse side of the first small projecting portion come into contact with a wall surface of the L-shaped hole to thereby determine a position of the substrate to the predetermined member in a first direction, and the second small projecting portion and a sidewall surface of the L-shaped projection on the reverse side of the second small projecting portion come into contact with the wall surface of the L-shaped hole to thereby determine a position of the substrate to the predetermined member in a second direction that crosses the first direction.

Preferably, the substrate assembly of the present invention is configured such that the predetermined member comprises an I-shaped projection formed in an I-shape as the projection, the substrate comprises an I-shaped hole formed in an I-shape as the hole, and the third small projecting portion and a sidewall surface of the I-shaped projection on the reverse side of the third small projecting portion come into contact with a wall surface of the I-shaped hole to thereby determine a position of the substrate to the predetermined member in the second direction.

Preferably, the substrate assembly of the present invention is configured such that the projection is formed with a component of the casing in one solid body.

According to the present invention, both of a highly precise positioning and easier assembling can be satisfied. That is, the clearance between the hole and the projection can be reduced to substantially zero by the small projecting portion and thus highly precise positioning can be achieved as well as easier assembling without holding the substrate by a screw or a hand.

### BRIEF DESCRIPTION OF THE DRAWINGS

FIG. 1 is a perspective view illustrating a structure of a substrate assembly according to example 1 of the present invention;

FIG. 2 is a development view illustrating a structure of a substrate assembly according to example 1 of the present invention; and

FIG. 3 is a plan view for explaining a structure of a positioning hole and a positioning projection of the substrate assembly according to example 1 of the present invention.

### PREFERRED MODES

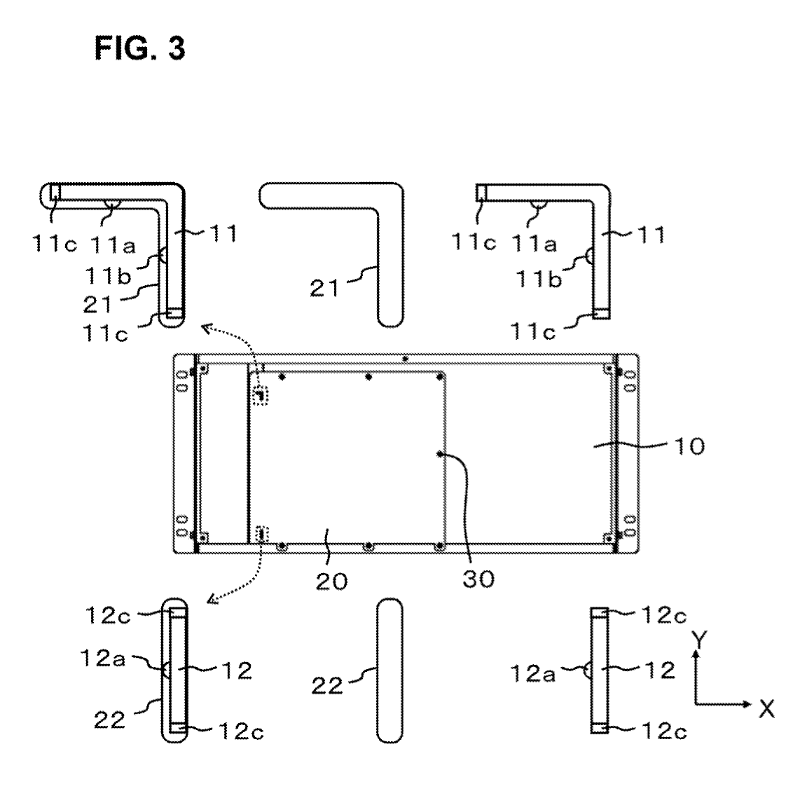

A substrate assembly according to an exemplary embodiment of the present invention is a substrate assembly which is formed by positioning a substrate (designated as 20 in FIG. 3) and installing the substrate onto a predetermined member (designated as 10 in FIG. 3) and configured such that the predetermined member (designated as 10 in FIG. 3) comprises a projection (designated as 11 and 12 in FIG. 3) which protrudes toward the substrate (designated as 20 in FIG. 3), the substrate (designated as 20 in FIG. 3) comprises a hole (designated as 21 and 22 in FIG. 3) into which the projection (designated as 11 and 12 in FIG. 3) is fitted at a position corresponding to the projection (designated as 11 and 12 in FIG. 3), the projection (designated as 11 and 12 in FIG. 3) comprises a small projecting portion (designated as 11a, 11b and 12a in FIG. 3) on a sidewall surface thereof, and the small projecting portion (designated as 11a, 11b and 12a in FIG. 3) and a sidewall surface of the projection (designated as 11 and 12 in FIG. 3) on the reverse side of the small projecting portion are in contact with a wall surface of the hole (designated as 21 and 22 in FIG. 3) to thereby determine a position of the substrate (designated as 20 in FIG. 3) to the predetermined member (designated as 10 in FIG. 3) in a predetermined direction (x-axis direction, y-axis direction).

### Example 1

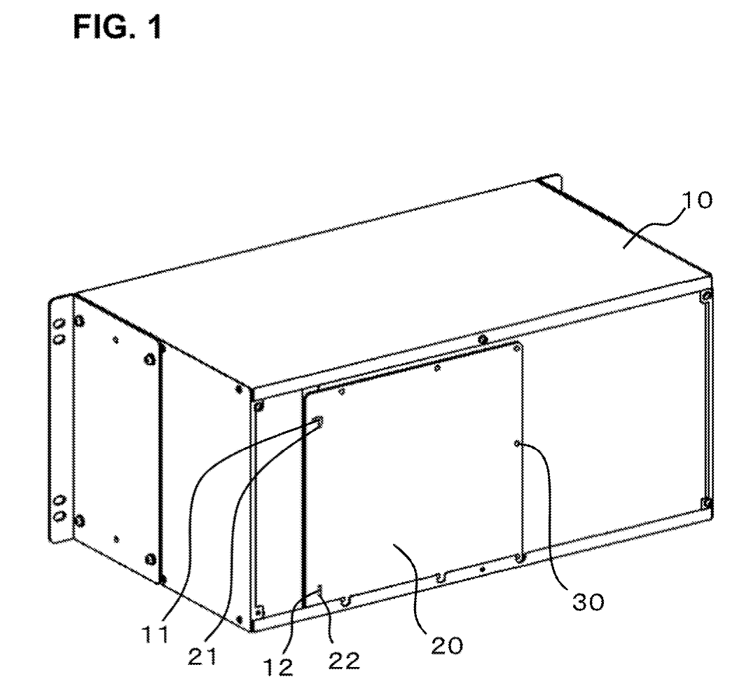

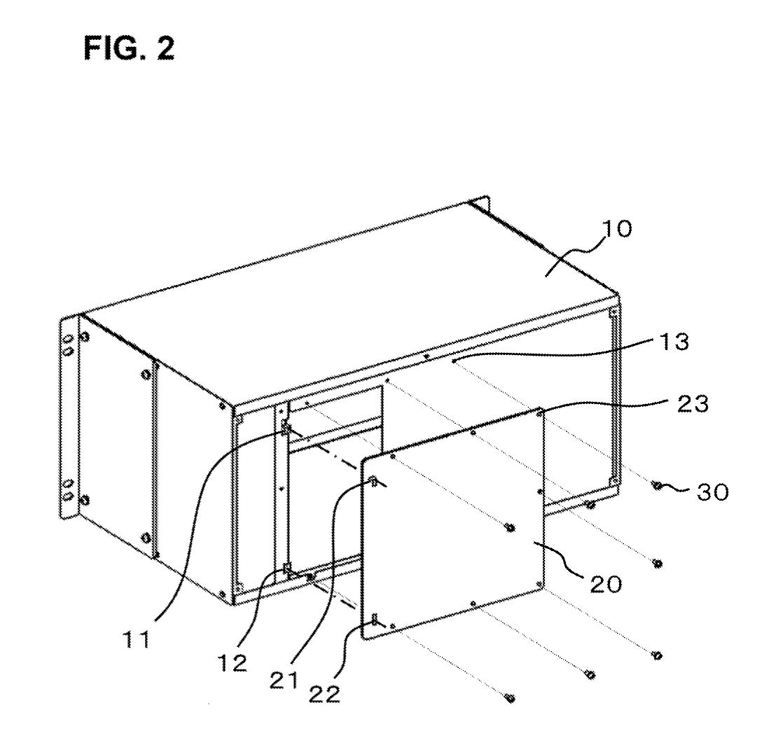

A substrate assembly according to Example 1 will be explained with reference to the drawings. FIG. 1 is a perspective view illustrating a structure of a substrate assembly according to Example 1 of the present invention. FIG. 2 is a development view illustrating a structure of a substrate assembly according to Example 1 of the present invention. FIG. 3 is a plan view for explaining a structure of a positioning hole and a positioning projection of the substrate assembly according to Example 1 of the present invention. A casing 10 is exemplified as a predetermined member of the substrate assembly in Example 1.

The substrate assembly is a substrate assembly in which a substrate 20 is positioned and installed onto a casing 10. The positioning of the substrate 20 to the casing 10 is achieved by fitting projections 11 and 12 of the casing 10 into holes 21 and 22 of the substrate 20.

The casing 10 is a box-type casing. The casing 10 illustrated in FIG. 1 is assembled from a metal plate, frame, screws, and the like; however, a one-body casing can be used. The casing 10 has an opening which communicates with inside at a specified position and the substrate 20 is installed so as to cover the opening. The casing 10 has an L-shaped projection 11, an I-shaped projection 12 and screw holes 13 in an area where the substrate 20 overlaps.

The L-shaped projection 11 is an L-shaped member protruding from an outer surface of the casing 10 for positioning the substrate 20 to the casing 10. The L-shaped projection 11 is arranged at a position corresponding to an L-shaped hole 21 of the substrate 20 and is inserted into the L-shaped hole 21. The L-shaped projection 11 is formed in one-body with a structural member of the casing 10. The L-shaped projection 11 has a first small projecting portion 11a and a second small projecting portion 11b. The first small projecting portion 11a and the second small projecting portion 11b are formed by a half punching or an embossing process. The first small projecting portion 11a is formed on a sidewall surface (sidewall surface on the underside in a y-axis direction in FIG. 3) of a first side of an L-shape of the L-shaped projection 11 and configured so as to make the clearance in the y-axis direction becomes zero by contacting (press-contacting) with an inside wall surface of the L-shaped hole 21 when the L-shaped projection 11 is inserted into the L-shaped hole 21. The second small projecting portion 11b is formed on a sidewall surface (sidewall surface on the left side in an x-axis direction in FIG. 3) of a second side (a side crossing (at right angles) with the first side) of the L-shape of the L-shaped projection 11 and configured so as to make the clearance in the x-axis direction becomes zero by contacting (press-contacting) with an inside wall surface of the L-shaped hole 21 when the L-shaped projection 11 is inserted into the L-shaped hole 21. The L-shaped projection 11 has tapered surfaces 11c at both end corners of the L-shape at a top surface of the projection. The tapered surface 11c plays a role as a guide when inserting the L-shaped projection 11 into the L-shaped hole 21.

The I-shaped projection 12 is an I-shaped member protruding from an outer surface of the casing 10 for positioning the substrate 20 to the casing 10. The I-shaped projection 12 is arranged at a position corresponding to an I-shaped hole 22 of the substrate 20 and is inserted into the I-shaped hole 22. The I-shaped projection 12 is formed in one-body with a structural member of the casing 10. The I-shaped projection 12 has a small projecting portion 12a on a sidewall surface. The small projecting portion 12a is formed by a half punching or an embossing process. The small projecting portion 12a is formed on a sidewall surface (sidewall surface on the left side in an x-axis direction in FIG. 3) of an I-shape of the I-shaped projection 12 and configured so as to make the clearance in the x-axis direction becomes zero by contacting (press-contacting) with an inside wall surface of the I-shaped hole 22 when the I-shaped projection 12 is inserted into the I-shaped hole 22. The I-shaped projection 12 has tapered surfaces 12c at both end corners of the I-shape at a top surface of the projection. The tapered surface 12c plays a role as a guide when inserting the I-shaped projection 12 into the I-shaped hole 22.

The screw hole 13 is a hole to hold the substrate 20 with a screw 30 and engages with the screw 30.

The substrate 20 is a plate member. The substrate 20 has the L-shaped hole 21, I-shaped hole 22 and a penetration hole 23.

The L-shaped hole 21 is an L-shaped penetration hole formed at a position corresponding to the L-shaped projection 11 of the casing 10 for positioning the substrate 20 to the casing 10. The L-shaped hole 21 is configured such that the L-shaped projection 11 is inserted therein and make the clearance in the y-axis direction becomes zero by contacting (press-contacting) the first small projecting portion 11a and a sidewall surface of the L-shaped projection 11, which is on the reverse side of the first small projecting portion 11a, with wall surfaces in the y-axis direction. The L-shaped hole 21 is also configured so as to make the clearance in the x-axis direction becomes zero by contacting (press-contacting) the second small projecting portion 11b and a sidewall surface of the L-shaped projection 11 on the reverse side of the second small projecting portion 11b with wall surfaces in the x-axis direction.

The I-shaped hole 22 is an I-shaped penetration hole formed at a position corresponding to the I-shaped projection 12 of the casing 10 for positioning the substrate 20 to the casing 10. The I-shaped hole 22 is configured such that the I-shaped projection 12 is inserted therein and make the clearance in the x-axis direction becomes zero by contacting (press-contacting) the third small projecting portion 12a and a sidewall surface of the I-shaped projection 12, which is on the reverse side of the third small projecting portion 12a, with wall surfaces in the x-axis direction.

The penetration hole 23 is a penetration hole formed at a position corresponding to the screw hole 13 of the casing 10 for inserting the screw 30.

The screw 30 is a member to fix the substrate 20 onto the casing 10 and inserted into the penetration hole 23 from outside of the substrate 20 so as to engage with the screw hole 13 of the casing 10.

When installing the substrate 20 onto the casing 10, the L-shaped projection 11 and the I-shaped projection 12 of the casing 10 are inserted into the L-shaped hole 21 and the I-shaped hole 22 of the substrate 20, respectively. As a result, the first small projecting portion 11a and the sidewall surface of the L-shaped projection 11 on the reverse side of the first small projecting portion come into contact (press-contact) with the wall surfaces in the y-axis direction of the L-shaped hole 21 to determine the position of the substrate 20 in the y-axis direction. The second small projecting portion 11b and the sidewall surface of the L-shaped projection 11 on the reverse side of the second small projecting portion come into contact (press-contact) with the wall surfaces in the x-axis direction of the L-shaped hole 21 and also the third small projecting portion 11a and the sidewall surface of the I-shaped projection 12 on the reverse side of the third small projecting portion come into contact (press-contact) with the wall surfaces in the x-axis direction of the I-shaped hole 22 to determine the position of the substrate 20 in the x-axis direction. After that, the screw 30 is inserted into the penetration hole 23 of the substrate 20 and screwed into the screw hole 13 of the casing 10 to fix the substrate 20 onto the casing 10 in a state that the position of the substrate 20 to the casing 10 is determined.

According to Example 1, following effects can be obtained.

A first effect is that it becomes possible to install the substrate with ease and assembling steps can be reduced because the substrate 20 can be temporarily fixed onto the casing 10 without holding it by a screw or a hand by inserting the projections 11 and 12 of the casing 10 into the holes 21 and 22 of the substrate 20.

A second effect is that a high precise positioning structure for the substrate 10 can be achieved because the positional precision of the projections 11 and 12 of the casing 10 is determined by only the precision in a punching a structural member of the casing 10.

A third effect is that both highly precise positioning as well as easier assembling at low cost can be achieved because no additional component or tool for positioning is necessary and assembling steps and component cost can be reduced by forming the projections 11 and 12 for positioning in one body with the structural member of the casing 10.

In Example 1, a substrate assembly is exemplified in which the substrate 20 is positioned and installed onto the casing 10. However, the present invention is not limited to this example and a metal plate or a resin molding can be used instead of the casing 10, and a print board, metal plate or resin molding substrate can be used instead of the substrate 20.

Modifications and adjustments of the exemplary embodiments and examples are possible within the scope of the overall disclosure (including claims) of the present invention and based on the basic technical concept of the invention. Various combinations and selections of various disclosed elements are possible within the scope of the claims of the present invention. That is, the present invention of course includes various variations and modifications that could be made by those skilled in the art according to the overall disclosure including the claims and the technical concept.

### EXPLANATION OF SYMBOLS

10 casing (predetermined member)
11 L-shaped projection
11a first small projecting portion
11b second small projecting portion
11c tapered surface
12 I-shaped projection
12a small projecting portion (third small projecting portion)
12c tapered surface
13 screw hole
20 substrate
21 L-shaped hole (first positioning hole)
22 I-shaped hole (second positioning hole)
23 penetration hole
30 screw

What is claimed is:

1-4. (canceled)

5. A substrate assembly formed by positioning a substrate and installing the substrate onto a predetermined member, wherein;
the predetermined member comprises a projection protruding toward the substrate,
the substrate comprises a hole at a position corresponding to the projection into which the projection is fitted, and
the projection comprises a small projecting portion on a sidewall surface, and wherein;
it is structured such that a position of the substrate to the predetermined member in a predetermined direction is determined by contacting the small projecting portion and a sidewall surface of the projection on the reverse side of the small projecting portion with a wall surface of the hole.

6. The substrate assembly as defined in claim 5, wherein;
the predetermined member comprises an L-shaped projection formed in an L-shape as the projection,
the substrate comprises an L-shaped hole formed in an L-shape as the hole,
the L-shaped projection comprises, as the small projecting portions, a first small projecting portion on one side of a sidewall surface of a first side region of the L-shape and a second small projecting portion on one side of a sidewall surface of a second side region that crosses the first side, and wherein;
it is structured such that a position of the substrate to the predetermined member in a first direction is determined by contacting the first small projecting portion and a sidewall surface of the L-shaped projection on the reverse side of the first small projecting portion with a wall surface of the L-shaped hole, and a position of the substrate to the predetermined member in a second direction that crosses the first direction is determined by contacting the second small projecting portion and a sidewall surface of the L-shaped projection on the reverse side of the second small projecting portion with the wall surface of the L-shaped hole.

7. The substrate assembly as defined in claim 6, wherein;
the predetermined member comprises an I-shaped projection formed in an I-shape as the projection,
the substrate comprises an I-shaped hole formed in an I-shape as the hole,
the I-shaped projection comprises a third small projecting portion on one side of a sidewall surface of the I-shape, and wherein;
it is structured such that a position of the substrate to the predetermined member in the second direction is determined by contacting the third small projecting portion and a sidewall surface of the I-shaped projection on the reverse side of the third small projecting portion with a wall surface of the I-shaped hole.

8. The substrate assembly as defined in claim 5, wherein;
the projection is formed on a component of the casing in one solid body.

9. The substrate assembly as defined in claim 5, wherein the small projecting portion is formed by a half punching or an embossing process.

10. The substrate assembly as defined in claim 5, wherein;
the predetermined member is a casing,
the projection protrudes from an outer surface of the casing, and wherein;
the small projecting portion formed on the sidewall of the projection comes into contact with the wall surface of the hole and the substrate is temporarily fixed onto the casing in a positioned state by fitting the projection into the hole of the substrate.
